(19) United States
(12) Patent Application Publication
(10) Pub. No.: US 2006/0166632 A1
(43) Pub. Date: Jul. 27, 2006

(54) Apparatus and method for automatically tuning frequency

(75) Inventors: Doo-Hee Yun, Yongin-si (KR); Young-Khon Moon, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/323,748

(22) Filed: Dec. 30, 2005

(30) Foreign Application Priority Data
Jan. 25, 2005 (KR) 2005-6776

(51) Int. Cl. H04B 1/18

(52) U.S. Cl. 455/182.2

(57) ABSTRACT

An automatic frequency tuning apparatus including an FM radio receiver for receiving a frequency tuning identification sound signal corresponding to a reception frequency of the FM radio receiver and then outputting the received frequency tuning identification sound signal; and a terminal's FM transmitter for outputting a frequency tuning identification sound while changing a transmission frequency, and automatically tuning the transmission frequency to the reception frequency of the FM radio receiver depending on whether a frequency tuning identification sound output from the FM radio receiver is input through a microphone. The automatic frequency tuning apparatus can automatically tune frequencies between the terminal's FM transmitter and the FM radio receiver, even without manual input by the user.

### PRIORITY

This application claims priority under 35 U.S.C. § 119 to an application entitled “Apparatus And Method For Automatically Tuning Frequency” filed in the Korean Intellectual Property Office on Jan. 25, 2005 and assigned Serial No. 2005-6776, the contents of which are incorporated herein by reference.

### BACKGROUND OF THE INVENTION

1. Field of the Invention

The present invention relates to a frequency tuning apparatus and a method thereof, and more particularly to a frequency tuning apparatus and a method thereof, capable of tuning a transmission frequency of a Frequency Modulated (FM) transmitter of various terminals (such as a telematics terminal, a mobile terminal, a hand-free terminal, etc.) to a reception frequency of an FM radio receiver equipped in a vehicle or the like.

2. Description of the Related Art

Recently, various terminals, such as a telematics terminal, a mobile terminal, a hand-free terminal, etc., having an audio signal output function have been developed. However, since these terminals have been manufactured in a small size so as to be easily carried and handled by the user, only a low-power speaker can easily be installed in most terminals. Therefore, it is impossible to output a high-power audio signal using only the terminal itself.

For this reason, terminals are currently equipped with an FM transmitter in order to transmit an audio signal to an FM radio receiver through the FM transmitter by allowing the audio signal to have an FM transmission frequency, so that the audio signal may be output through the high-power speaker of the FM radio receiver.

However, in order to transmit an audio signal, which is output from the FM transmitter of a terminal, to the FM radio receiver, it is necessary to tune the FM transmission frequency of the terminal to the reception frequency of the FM radio receiver.

FIG. 1 is a block diagram illustrating the construction of a conventional apparatus for tuning the transmission frequency of the FM transmitter of a terminal to the reception frequency of the FM radio receiver.

A terminal's FM transmitter 10 includes an audio unit 12, a transmission frequency setting unit 14, and an FM transmitter 16. The terminal's FM transmitter 10 directly receives the same frequency as the reception frequency of an FM radio receiver 20 through the transmission frequency setting unit 14 from the user, and sets the transmission frequency of the FM transmitter 16. The terminal's FM transmitter 10 FM-modulates an audio signal provided from the audio unit 12, based on the transmission frequency set by input of the user, and outputs the FM-modulated audio signal through an antenna. Then, the FM radio receiver 20, contained in a vehicle or the like, receives and demodulates an FM frequency signal corresponding to its own reception frequency through an FM radio unit 22, and outputs the demodulated signal through a speaker 24.

However, the conventional frequency tuning apparatus, as described above, requires manual input/adjustment to tune the FM transmission frequency of the terminal to the reception frequency of the FM radio receiver. That is, the user of the frequency tuning apparatus must directly input the numeric value of a desired frequency, or must push frequency-up/down buttons many times, which causes inconvenience for the user. In addition, the conventional frequency tuning apparatus requires that the user should manually reset the transmission frequency of the FM transmitter 16 whenever the reception frequency of the FM radio receiver 20 changes, which causes further inconvenience for the user. Moreover, when the FM radio receiver 20 is contained in a vehicle, the user must manually set the FM transmission frequency while driving the vehicle, which also causes considerable inconvenience for the user.

### SUMMARY OF THE INVENTION

Accordingly, the present invention has been made to solve the above-mentioned problems occurring in the prior art, and an object of the present invention is to provide an automatic frequency tuning apparatus and method which can automatically tune the frequencies between an FM transmitter and an FM radio receiver, without requiring the user's manual adjustment of the frequency.

Another object of the present invention is to provide an automatic frequency tuning apparatus and method, which can tune the transmission frequency of the FM transmitter to the reception frequency of the FM radio receiver by automatically finding a tuning frequency between the FM transmitter and the FM radio receiver upon the request of a user.

To accomplish these objects, in accordance with one aspect of the present invention, there is provided an automatic frequency tuning apparatus including an FM radio receiver for receiving a frequency tuning identification sound signal corresponding to a reception frequency of the FM radio receiver and then outputting the received frequency tuning identification sound signal; and a terminal's FM transmitter for outputting a frequency tuning identification sound while changing a transmission frequency, and automatically tuning the transmission frequency to the reception frequency of the FM radio receiver depending on whether a frequency tuning identification sound output from the FM radio receiver is input through a microphone.

In accordance with another aspect of the present invention, there is provided an automatic frequency tuning method including outputting, by a terminal's FM transmitter, a frequency tuning identification sound while changing a transmission frequency, according to an automatic frequency setting request of a user; receiving, by an FM radio receiver, a frequency tuning identification sound signal corresponding to a reception frequency of the FM radio receiver, from among frequency tuning identification sound signals, and then outputting the received frequency tuning identification sound signal; and automatically tuning, by the terminal's FM transmitter, the transmission frequency to the reception frequency of the FM radio receiver, according to whether a frequency tuning identification sound output from the FM radio receiver is input through a microphone.

In accordance with still another aspect of the present invention, there is provided a method for tuning a transmission frequency of a terminal's FM transmitter to a reception frequency of an FM radio receiver, the method including storing a current transmission frequency and initializing a transmission frequency of an FM transmitter as a search-start frequency, when a user presses a frequency search button; transmitting a frequency tuning identification sound while increasing the transmission frequency from the search-start frequency to a search-end frequency with a predetermined unit interval, and measuring a pulse period of a signal input through a microphone; and setting the transmission frequency as a tuned frequency and stopping a procedure of transmitting the frequency tuning identification sound, when the measured period of a signal input through the microphone is equal to a period of the frequency tuning identification sound.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a conventional frequency tuning apparatus;

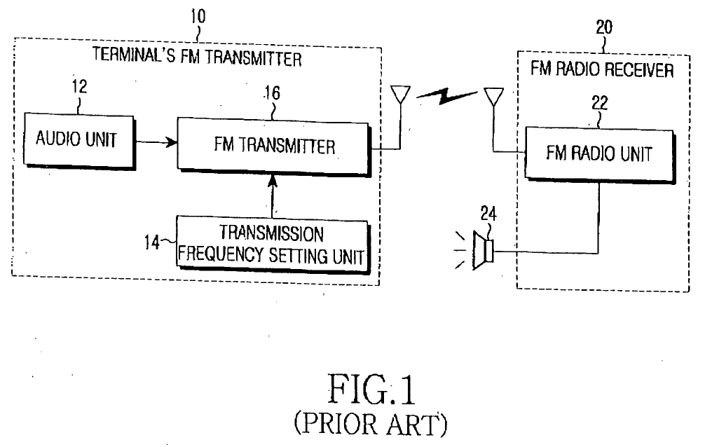

FIG. 2 is a block diagram illustrating the arrangement of an automatic frequency tuning apparatus according to an embodiment of the present invention;

FIG. 3 is a flowchart illustrating an automatic frequency tuning method according to an embodiment of the present invention; and

FIG. 4 is a flowchart illustrating a procedure of tuning a transmission frequency of an FM transmitter to a reception frequency of a FM radio receiver according to an embodiment of the present invention.

### DETAILED DESCRIPTION OF THE PREFERRED EMBODIMENT

Hereinafter, preferred embodiments of the present invention will be described with reference to the accompanying drawings. In the following description of the embodiments of the present invention, a detailed description of known functions and configurations incorporated herein will be omitted when it may obscure the subject matter of the present invention.

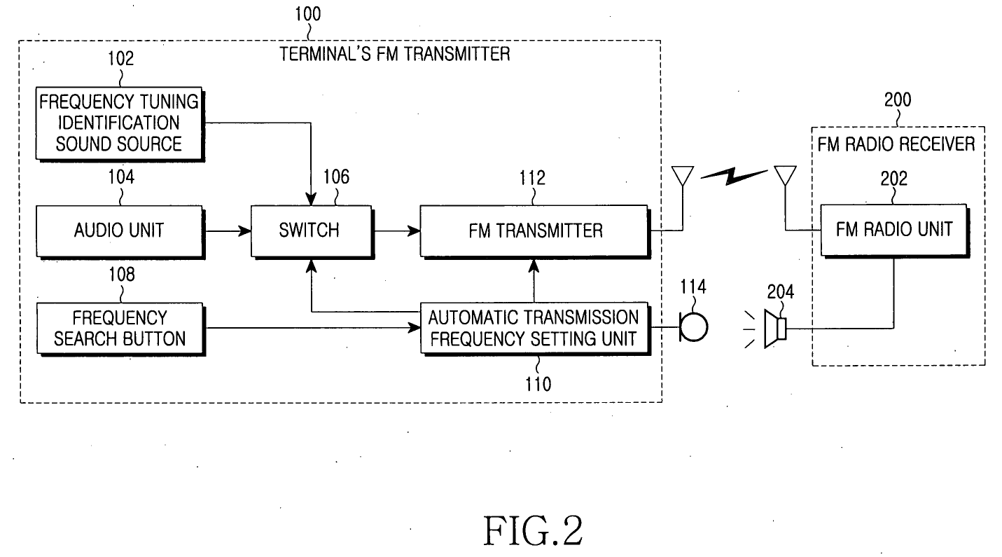

FIG. 2 is a block diagram illustrating the arrangement of a frequency tuning apparatus according to the present invention. The frequency tuning apparatus according to an embodiment of the present invention includes a terminal's FM transmitter 100 and an FM radio receiver 200.

The terminal's FM transmitter 100 outputs frequency tuning identification sounds while changing an FM transmission frequency. Also, the terminal's FM transmitter 100 checks if its frequency is tuned to the frequency of the FM radio receiver 200, and automatically sets its transmission frequency, based on whether a frequency tuning identification sound is input through a microphone 114.

The terminal's FM transmitter 100 may include a frequency tuning identification sound source 102, an audio unit 104, a switch 106, a frequency search button 108, an automatic transmission frequency setting unit 110, an FM transmitter 112, and the microphone 114.

The frequency tuning identification sound source 102 provides frequency tuning identification sounds for frequency-tuning with the FM radio receiver 200. In this case, the frequency tuning identification sound may be a pulse sound having a predetermined period. The audio unit 104 provides a desired audio signal, which is to be transmitted at high power through the FM transmitter 112.

The switch 106 performs a switching operation to connect either the frequency tuning identification sound source 102 or the audio unit 104 to the FM transmitter 112 according to a predetermined control. When the frequency tuning identification sound source 102 is connected to the FM transmitter 112, a frequency tuning identification sound is provided to the FM transmitter 112. When the audio unit 104 is connected to the FM transmitter 112, an audio signal to be output is provided to the FM transmitter 112.

When sensing an input from the user, the frequency search button 108 outputs an automatic transmission frequency set request signal. In this case, the automatic transmission frequency set request signal refers to a signal for requesting that an FM transmission frequency is automatically set as the same frequency as the reception frequency of the FM radio receiver 200.

Upon receiving the automatic transmission frequency set request signal, the automatic transmission frequency setting unit 110 connects the frequency tuning identification sound source 102 to the FM transmitter 112, and changes the transmission frequency of the FM transmitter 112 from a search-start frequency to a search-end frequency with a predetermined unit interval. When checking a signal input through the microphone 114 and sensing that a frequency tuning identification sound signal is input, the automatic transmission frequency setting unit 110 determines if the terminal's FM transmitter 100 is frequency-tuned to the FM radio receiver 200, and automatically sets the transmission frequency of the FM transmitter 112 as a tuning frequency.

The FM transmitter 112 FM-modulates and outputs a frequency tuning identification sound while changing its frequency from a search-start frequency to a search-end frequency at a predetermined interval, according to the control of the automatic transmission frequency setting unit 110. When the transmission frequency of the FM transmitter 112 is tuned to the reception frequency of the FM radio receiver 200, the FM transmitter 112 FM-modulates an audio signal provided from the audio unit 104 by means of the tuning frequency, and then outputs the modulated signal through an antenna.

The FM radio receiver 200 may be separately or integrally constructed in a vehicle, and includes an FM radio unit 202 and a speaker 204. When the reception frequency of the FM radio unit 202 is equal to the transmission frequency of the terminal's FM transmitter 100, the FM radio unit 202 can receive and demodulate a frequency tuning identification sound signal. The speaker 204 outputs a frequency tuning identification sound demodulated by the FM radio unit 202.

In this case, the frequency tuning identification sound output through the speaker 204 is transmitted to the automatic transmission frequency setting unit 110 through the microphone 114 of the terminal's FM transmitter 100, so as to be used to determine if the terminal's FM transmitter 100 is frequency-tuned to the FM radio receiver 200.

Hereinafter, the method for frequency tuning between the terminal's FM transmitter 100 and the FM radio receiver 200 will be described according to the present invention.

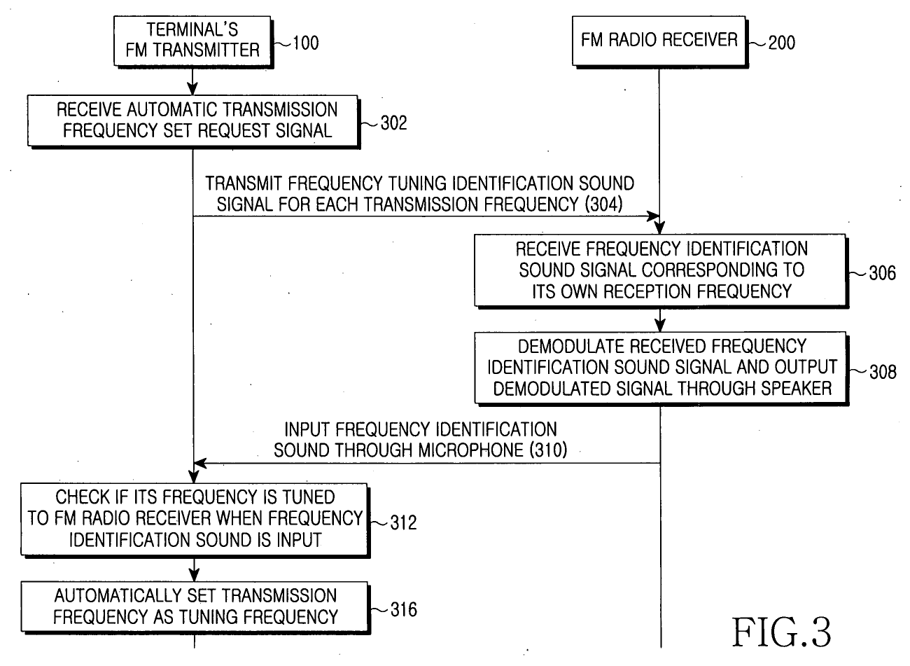

FIG. 3 is a flowchart illustrating a frequency tuning method according to an embodiment of the present invention. When a frequency search button 108 is pressed by the user, the terminal's FM transmitter 100 receives an automatic transmission frequency set request signal in step 302. In this case, the automatic transmission frequency set request signal refers to a signal for requesting that the FM transmission frequency of the terminal's FM transmitter 100 be automatically set at the same frequency as the FM reception frequency of the FM radio receiver 200.

Upon receiving the automatic transmission frequency set request signal, the terminal's FM transmitter 100 transmits a frequency tuning identification sound signal while changing an FM transmission frequency in step 304. That is, the terminal's FM transmitter 100 FM-modulates and outputs a frequency tuning identification sound while changing its transmission frequency from a search-start frequency to a search-end frequency with a predetermined unit interval.

In step 306, the FM radio receiver 200 receives a frequency tuning identification sound signal corresponding to its own reception frequency, from among frequency tuning identification sound signals output from the terminal's FM transmitter 100. In step 308, the FM radio receiver 200 demodulates the received frequency tuning identification sound signal and outputs the demodulated signal through the speaker 204.

Accordingly, the terminal's FM transmitter 100 receives the frequency tuning identification sound signal, which has been output through the speaker 204 of the FM radio receiver 200, through the microphone 114 in step 310. When the frequency tuning identification sound signal is received through the microphone 114, as described above, the terminal's FM transmitter 100 determines that the transmission frequency of the terminal's FM transmitter 100 is tuned to the reception frequency of the FM radio receiver 200 (step 312).

When the terminal's FM transmitter 100 determines that a transmission frequency of the terminal's FM transmitter 100 is tuned to the reception frequency of the FM radio receiver 200, the terminal's FM transmitter 100 automatically sets the relevant transmission frequency of the FM transmitter 112 as a tuning frequency in step 316.

According to the FM transmission frequency tuning method of the present invention, as described above, it is possible to automatically tune frequencies between the terminal's FM transmitter 100 and the FM radio receiver 200, even without manual input by the user.

Hereinafter, the procedure for tuning the transmission frequency of the terminal's FM transmitter 100 to the reception frequency of the FM radio receiver 200 will be described in more detail.

First, the terminal's FM transmitter 100 stores a current transmission frequency of the FM transmitter 112 when the frequency search button is pressed. Then, the terminal's FM transmitter 100 searches for the reception frequency of the FM radio receiver 200, while increasing the transmission frequency, by means of a frequency tuning identification sound having a predetermined period and the microphone 114. As a result of the search, when the terminal's FM transmitter 100 determines that a transmission frequency of the FM transmitter 112 is tuned to the reception frequency of the FM radio receiver 200, the terminal's FM transmitter 100 automatically sets the relevant transmission frequency of the FM transmitter 112 as the reception frequency of the FM radio receiver 200. In contrast, when the terminal's FM transmitter 100 determines that a transmission frequency of the FM transmitter 112 is not tuned to the reception frequency of the FM radio receiver 200, the terminal's FM transmitter 100 sets a stored transmission frequency as the transmission frequency of the FM transmitter 112.

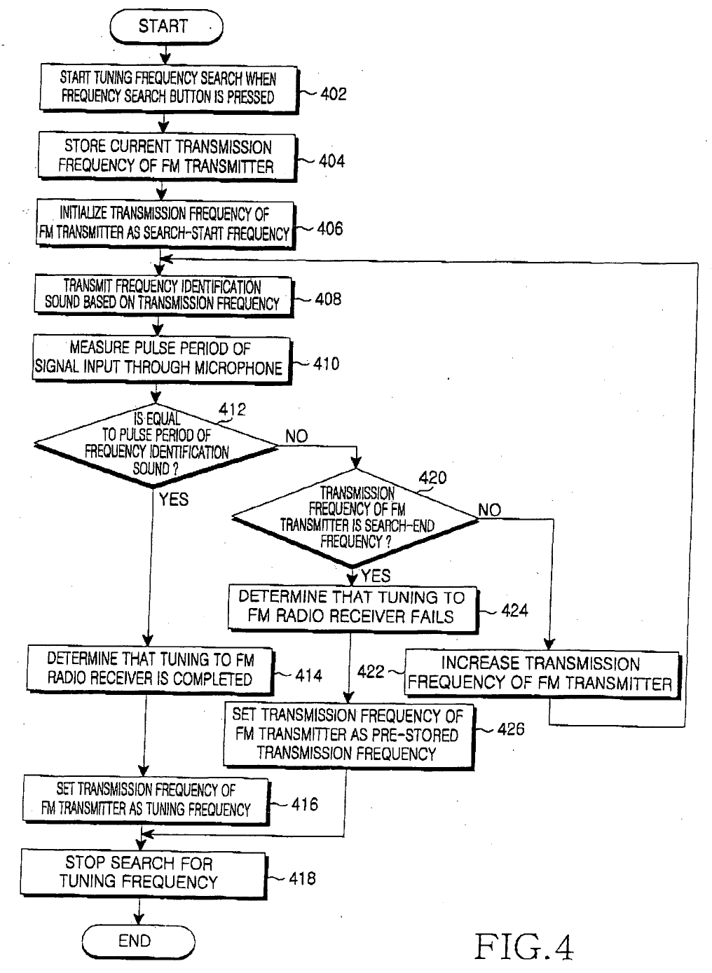

This frequency tuning procedure of the terminal's FM transmitter 100 is shown in detail in FIG. 4. FIG. 4 is a flowchart illustrating an FM transmission frequency tuning procedure of the terminal's FM transmitter 100 according to the present invention.

In step 402, the terminal's FM transmitter 100 receives an input signal from the frequency search button 108. That is, when the frequency search button 108 is pressed by the user, the terminal's FM transmitter 100 receives an automatic transmission frequency set request signal from the frequency search button 108. Then, the terminal's FM transmitter 100 initiates a frequency search, in order to find the FM transmission frequency of the terminal's FM transmitter 100 which is tuned to the reception frequency of the FM radio receiver 200.

When the frequency search is initiated in order to find the FM transmission frequency of the terminal's FM transmitter 100 which is tuned to the reception frequency of the FM radio receiver 200, the terminal's FM transmitter 100 stores a current transmission frequency “F” of the FM transmitter 112 as a previous transmission frequency “F_prev” in step 404. This enables the transmission frequency of the FM transmitter 112 to be restored based on the previous transmission frequency “F_prev”, when a tuning fails between a transmission frequency of the terminal's FM transmitter 100 and the reception frequency of the FM radio receiver 200.

After this, the terminal's FM transmitter 100 initializes the transmission frequency of the FM transmitter 112 as a search-start frequency “F_start” in step 406. In this embodiment of the present invention, a frequency at which the terminal's FM transmitter 100 starts an initial transmission frequency search is called a “search-start frequency”, and a frequency at which the terminal's FM transmitter 100 ends the transmission frequency search is called a “search-end frequency”. A transmission frequency search range of the FM transmitter 112 may be the reception frequency range of the FM radio receiver 200. Also, the search-start frequency and search-end frequency may be either the lowest frequency or highest frequency within the reception frequency range of the FM radio receiver 200. For instance, when the FM radio receiver 200 has the reception frequency range of 88 to 108 MHz, it is possible that the search-start frequency becomes 88 MHz and the search-end frequency becomes 108 MHz. On the contrary, it is also possible that the search-start frequency becomes 108 MHz and the search-end frequency becomes 88 MHz.

After the transmission frequency of the FM transmitter 112 is initialized as the search-start frequency, as described above, the terminal's FM transmitter 100 FM-modulates a frequency tuning identification sound by using its transmission frequency and transmits the FM-modulated frequency tuning identification sound (step 408).

In step 410, the terminal's FM transmitter 100 measures the pulse period of a signal input through the microphone 114. That is, the terminal's FM transmitter 100 monitors a signal input through the microphone 114 during a predetermined time period, and measures the period of the input signal.

In step 412, the terminal's FM transmitter 100 determines if the pulse period of the signal input through the microphone 114 is equal to the pulse period of the frequency tuning identification sound.

When the pulse period of the signal input through the microphone 114 is equal to the pulse period of the frequency tuning identification sound, it means that the FM radio receiver 200 receives the frequency tuning identification sound which has been output from the terminal's FM transmitter 100, and then outputs the received frequency tuning identification sound. Also, this means that the transmission frequency of the terminal's FM transmitter 100 and the reception frequency of the FM radio receiver 200 are tuned to each other.

In contrast, when the pulse period of the signal input through the microphone 114 is not equal to the pulse period of the frequency tuning identification sound, it means that the FM radio receiver 200 does not receive the frequency tuning identification sound output from the terminal's FM transmitter 100. Also, it means that the transmission frequency of the terminal's FM transmitter 100 and the reception frequency of the FM radio receiver 200 are not tuned to each other.

When the pulse period of the signal input through the microphone 114 is equal to the pulse period of the frequency tuning identification sound, the terminal's FM transmitter 100 determines that the terminal's FM transmitter 100 is tuned to the FM radio receiver 200 (step 414).

When it is determined, as described above, that the transmission frequency of the terminal's FM transmitter 100 is tuned to the reception frequency of the FM radio receiver 200, the terminal's FM transmitter 100 sets the transmission frequency of the FM transmitter 112 as a tuning frequency (step 416). In step 418, the terminal's FM transmitter 100 stops the tuning frequency search with respect to the FM radio receiver 200.

When the pulse period of the signal input through the microphone 114 is not equal to the pulse period of the frequency tuning identification sound, the terminal's FM transmitter 100 proceeds to step 420, in which the terminal's FM transmitter 100 determines if the current transmission frequency of the FM transmitter 112 is the search-end frequency. For instance, when the FM radio receiver 200 has a reception frequency range of 88 to 108 MHz, and the search-end frequency is set as 108 MHz, the terminal's FM transmitter 100 determines if the current transmission frequency is 108 MHz.

When the current transmission frequency of the FM transmitter 112 is not 108 MHz (which is the search-end frequency), the terminal's FM transmitter 100 increases the transmission frequency of the FM transmitter 112 by a predetermined amount (step 422). After step 422 has been performed, the terminal's FM transmitter 100 returns to step 408, in which the terminal's FM transmitter 100 searches for a transmission frequency tuned to the reception frequency of the FM radio receiver 200, or the terminal's FM transmitter 100 continuously performs frequency search until the transmission frequency of the FM transmitter 112 becomes the search-end frequency. That is, when the current transmission frequency of the FM transmitter 112 is not the search-end frequency, it means that at least one frequency to be checked still remains, so the frequency search is continued with a frequency increasing by a predetermined amount. In this case, the transmission frequency of the FM transmitter 112 may increase by 0.1 MHz. The reason for increasing the transmission frequency of the FM transmitter 112 by 0.1 MHz is that the frequencies of the normal FM radio receiver are set in a unit of 0.1 MHz.

When the pulse period of the signal input through the microphone 114 is not equal to the pulse period of the frequency tuning identification sound, and the current transmission frequency of the FM transmitter 112 is the search-end frequency, the terminal's FM transmitter 100 determines that frequency tuning between the terminal's FM transmitter 100 and the FM radio receiver 200 fails (step 424). That is, when the pulse period of the signal input through the microphone 114 is not equal to the pulse period of the frequency tuning identification sound, and the current transmission frequency of the FM transmitter 112 has reached the search-end frequency, the terminal's FM transmitter 100 determines that the terminal's FM transmitter 100 has not found a tuning frequency despite the search being performed for the entire reception frequency range of the FM radio receiver 200, so terminal's FM transmitter 100 performs step 424 as described above.

When the tuning frequency search fails, the terminal's FM transmitter 100 sets the transmission frequency of the FM transmitter 112 as a previously stored transmission frequency “F_prev” (step 426), and then stops the tuning frequency search procedure with respect to the FM radio receiver 200 (step 418).

According to the present invention as described above, it is possible to automatically tune frequencies between the terminal's FM transmitter 100 and the FM radio receiver 200, even without manual input by the user.

Also, the present invention can remove the inconvenience of the user because it is not necessary for the user to directly input the transmission frequency of the terminal's FM transmitter in order to tune frequencies between the terminal's FM transmitter and the FM radio receiver.

Also, in the case of tuning the transmission frequency of terminal's FM transmitter to the reception frequency of an FM radio receiver contained in a vehicle, this frequency tuning is automatically performed without manual input by the user, so that a driver can easily use the frequency tuning function without disturbing his/her driving.

In addition, the present invention is realized by utilizing an existing microphone equipped in the majority of terminals, such as a telematics terminal, a mobile terminal, a hand-free terminal, etc., so that the utility of the microphone is improved, and an additional cost for a separate microphone is not necessary.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. An automatic frequency tuning apparatus comprising:
an FM radio receiver for receiving a frequency tuning identification sound signal corresponding to a reception frequency of the FM radio receiver and then outputting the received frequency tuning identification sound signal; and
an FM transmitter of a terminal, for outputting a frequency tuning identification sound while changing a transmission frequency, and automatically tuning the transmission frequency to the reception frequency of the FM radio receiver depending on whether a frequency tuning identification sound output from the FM radio receiver is input through a microphone.

2. The apparatus as claimed in claim 1, wherein the FM radio receiver comprises:
an FM radio unit for receiving and demodulating a frequency tuning identification sound signal corresponding to a reception frequency of the FM radio unit, from among frequency tuning identification sound signals; and
a speaker for outputting the demodulated frequency tuning identification sound signal.

3. The apparatus as claimed in claim 2, wherein the FM radio receiver is contained in a vehicle.

4. The apparatus as claimed in claim 1, wherein the FM transmitter of the terminal comprises:
a frequency tuning identification sound source for providing a frequency tuning identification sound which is used to determine if the terminal's FM transmitter is frequency-tuned to the FM radio receiver;
an FM transmitter for FM-modulating and outputting the frequency tuning identification sound while changing a transmission frequency according to a predetermined control;
a microphone for receiving a frequency tuning identification sound output from the FM radio receiver; and
an automatic transmission frequency setting unit for changing a transmission frequency of the FM transmitter according to a user's request, and automatically tuning a transmission frequency of the FM transmitter to a reception frequency of the FM radio receiver when a frequency tuning identification sound signal is input through the microphone.

5. The apparatus as claimed in claim 4, wherein the automatic transmission frequency setting unit controls that the transmission frequency of the FM transmitter changes at a predetermined interval within a reception frequency range of the FM radio receiver.

6. The apparatus as claimed in claim 4, wherein the FM radio receiver has a reception frequency range of 88 MHz to 108 MHz.

7. The apparatus as claimed in claim 4, further comprising a frequency search button, which outputs a signal for requesting that an FM transmission frequency be automatically tuned to the reception frequency of the FM radio receiver when the frequency search button is pressed.

8. The apparatus as claimed in claim 4, further comprising an audio unit which provides an audio signal to be output from the FM radio receiver.

9. The apparatus as claimed in claim 8, further comprising a switch, which connects the frequency tuning identification sound source to the FM transmitter when a search for a tuning frequency between the terminal's FM transmitter and the FM radio receiver is performed, and connects the audio unit to the FM transmitter when the search for a tuning frequency between the terminal's FM transmitter and the FM radio receiver has been finished.

10. The apparatus as claimed in claim 4, wherein the frequency tuning identification sound is a pulse sound having a predetermined period.

11. The apparatus as claimed in claim 10, wherein the automatic transmission frequency setting unit measures a period of a signal input through the microphone, and determines if the frequency tuning identification sound is input through the microphone by checking whether the measured period is equal to a period of the frequency tuning identification sound.

12. An automatic frequency tuning method comprising:
outputting, by an FM transmitter of a terminal, a frequency tuning identification sound while changing a transmission frequency, according to an automatic frequency setting request of a user;
receiving, by an FM radio receiver, a frequency tuning identification sound signal corresponding to a reception frequency of the FM radio receiver, from among frequency tuning identification sound signals, and then outputting the received frequency tuning identification sound signal; and
automatically tuning, by the terminal's FM transmitter, the transmission frequency to the reception frequency of the FM radio receiver, according to whether a frequency tuning identification sound output from the FM radio receiver is input through a microphone.

13. The method as claimed in claim 12, wherein the outputting step further comprises:
receiving an automatic transmission frequency set request signal when a user presses a frequency search button;
changing a transmission frequency of an FM transmitter from a search-start frequency to a search-end frequency with a predetermined unit interval when the automatic transmission frequency set request signal is received; and
FM-modulating and outputting a frequency tuning identification sound, based on the changed frequency.

14. The method as claimed in claim 12, wherein the receiving step further comprises:
receiving a frequency tuning identification sound signal corresponding to the reception frequency of the FM radio receiver, from among frequency tuning identification sound signals output from the terminal's FM transmitter; and
demodulating the received frequency tuning identification sound signal, and outputting a demodulated frequency tuning identification sound through a speaker.

15. The method as claimed in claim 12, wherein the step of automatically turning further comprises:
checking a signal input through the microphone;
determining if a frequency tuning identification sound transmitted from the terminal's FM transmitter is input through the microphone, based on a result of the check;
determining if a transmission frequency of the terminal's FM transmitter is tuned to a reception frequency of the FM radio receiver, based on a result of the determination of whether a frequency tuning identification sound is input; and
automatically tuning the transmission frequency to the reception frequency of the FM radio receiver, based on a result of the determination concerning the tuning.

16. A method for tuning a transmission frequency of an FM transmitter of a terminal to a reception frequency of an FM radio receiver, comprising:
storing a current transmission frequency and initializing a transmission frequency of an FM transmitter as a search-start frequency, when a user presses a frequency search button;
transmitting a frequency tuning identification sound while increasing the transmission frequency from the search-start frequency to a search-end frequency with a predetermined unit interval, and measuring a pulse period of a signal input through a microphone; and
setting the transmission frequency as a tuned frequency and stopping a procedure of transmitting the frequency tuning identification sound, when the measured period of a signal input through the microphone is equal to a period of the frequency tuning identification sound.

17. The method as claimed in claim 16, further comprising:
determining if the transmission frequency is a search-end frequency, when the measured period of a signal input through the microphone differs from the period of the frequency tuning identification sound; and
continuously performing the frequency tuning identification sound transmission procedure when the transmission frequency is not a search-end frequency, and setting the transmission frequency as the stored transmission frequency and stopping the frequency tuning identification sound transmission procedure when the transmission frequency is a search-end frequency.

18. The method as claimed in claim 16, wherein the search-start frequency and the search-end frequency are included within a reception frequency range of the FM radio receiver.

19. The method as claimed in claim 16, wherein the search-start frequency is 88 MHz, and the search-end frequency is 108 MHz.

20. The method as claimed in claim 16, wherein the predetermined unit interval is 0.1 MHz.
